(19) United States
(12) Patent Application Publication
(10) Pub. No.: US 2014/0164070 A1
(43) Pub. Date: Jun. 12, 2014

(54) PROBABILISTIC CARBON CREDITS CALCULATOR

(71) Applicant: MICROSOFT CORPORATION, Redmond, WA (US)

(72) Inventor: Matthew James Smith, Cambridge (GB)

(73) Assignee: MICROSOFT CORPORATION, Redmond, WA (US)

(21) Appl. No.: 13/709,347

(22) Filed: Dec. 10, 2012

(51) Int. Cl. G06Q 10/06

(52) U.S. Cl. CPC G06Q 10/06375
USPC 705/7.37

(57) ABSTRACT

A probabilistic carbon credits calculator may be used to calculate carbon credit monetary values for specified geographical areas, time periods, land uses, climate scenarios and other factors. For example, different land use scenarios may be assessed in terms of carbon credit monetary value to aid decisions about whether to return pasture to forest, whether to deforest an area and other such land use decisions. In various embodiments, predictions of terrestrial carbon amounts and certainty of those predictions are obtained from a carbon model and the predictions may be compared with comparison data and combined with carbon credit market data or other financial estimates of carbon value. In various examples the comparison data comprises empirical data and/or carbon model predictions. In various embodiments, certainty of predictions and/or comparison data is used to assess certainty of calculated carbon credit monetary values.

### BACKGROUND

Increasing awareness of the need to control greenhouse gas emissions has led to the development of carbon credits and the introduction of markets for trading carbon credits. A carbon credit can be thought of as a certificate which assigns a monetary value to a reduction or offset of greenhouse gas emissions that is equivalent to a specified amount of carbon, such as one metric tonne of carbon dioxide or equivalent greenhouse gas.

There exists widespread uncertainty surrounding the future value and sustainability of carbon markets. Whilst the general idea of supporting activities that encourage the mitigation or reduction of greenhouse gasses seems like a good one, knowledge and understanding of the economic and ecological mechanisms to make such an idea effective still needs improvement.

Carbon credits may be generated in a variety of ways such as through the reduction of previously-committed emissions or from the extraction of greenhouse gasses from the atmosphere. In order to generate carbon credits in these ways there is a need to quantify the amount of carbon present and sequestered or released over time.

Carbon credits may be generated through various changes in land use practices. The two examples are through the prevention of previously planned vegetation removal (mostly deforestation), which prevents carbon dioxide emissions, or through the growth of vegetation (mostly forests), which sequesters carbon from the atmosphere.

A variety of methods are used to quantify terrestrial carbon, typically involving surveys of sites being managed and extrapolation of measurements made to provide estimates of the amount of carbon held in different pools across an area. This is time consuming and expensive and the expense may detriment the financial viability of projects to reduce greenhouse gas emissions.

The embodiments described below are not limited to implementations which solve any or all of the disadvantages of known systems for calculating carbon credits.

### SUMMARY

The following presents a simplified summary of the disclosure in order to provide a basic understanding to the reader. This summary is not an extensive overview of the disclosure and it does not identify key/critical elements or delineate the scope of the specification. Its sole purpose is to present a selection of concepts disclosed herein in a simplified form as a prelude to the more detailed description that is presented later.

A probabilistic carbon credits calculator may be used to calculate carbon credit monetary values for specified geographical areas, time periods, land uses, climate scenarios and other factors. For example, different land use scenarios may be assessed in terms of carbon credit monetary value to aid decisions about whether to return pasture to forest, whether to deforest an area and other such land use decisions. In various embodiments, predictions of terrestrial carbon amounts and certainty of those predictions are obtained from a carbon model and the predictions may be compared with comparison data and combined with carbon credit market data, both of which may also come with estimates of certainty. Carbon credit price estimates may also be provided as user inputs or from other data sources with or without associated uncertainty. In various examples the comparison data may comprise empirical data, model predictions and/or other algorithmically transformed data such as raw or extrapolated empirical data or processed satellite data. In various embodiments, supplementary data, such as maps detailing land use classifications and ecosystem services, may also be incorporated to aid in decision making. In various embodiments, certainty of predictions and/or comparison data is used to assess certainty of calculated carbon credit monetary values.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a carbon credits calculator at a computing device being used to display carbon credit monetary values for a geographical area;

FIG. 2 is a schematic diagram of a carbon credits calculator in communication with a probabilistic carbon model and an interface to comparison data;

FIG. 3 is a flow diagram of a method at a carbon credits calculator;

FIG. 4 is a flow diagram of a method at a carbon credits calculator;

FIG. 5 is a graph illustrating a process of calculating carbon credits gained through carbon fixation;

FIG. 6 is a graph illustrating a process of calculating carbon credits gained through carbon protection;

FIG. 7 is a schematic diagram of a system for training a multi-component model such as the probabilistic carbon model of FIG. 1;

FIG. 8 is a schematic diagram of components of a terrestrial carbon model;

FIG. 9 illustrates an exemplary computing-based device in which embodiments of a carbon credits calculator may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a remote computing device providing a world web service through a web browser, the system described is provided as an example and not a limitation. As those skilled in the art will appreciate, the present examples are suitable for application in a variety of different types of computing systems including smart phones, tablet computers, personal digital assistants, laptop computers, games consoles, and others.

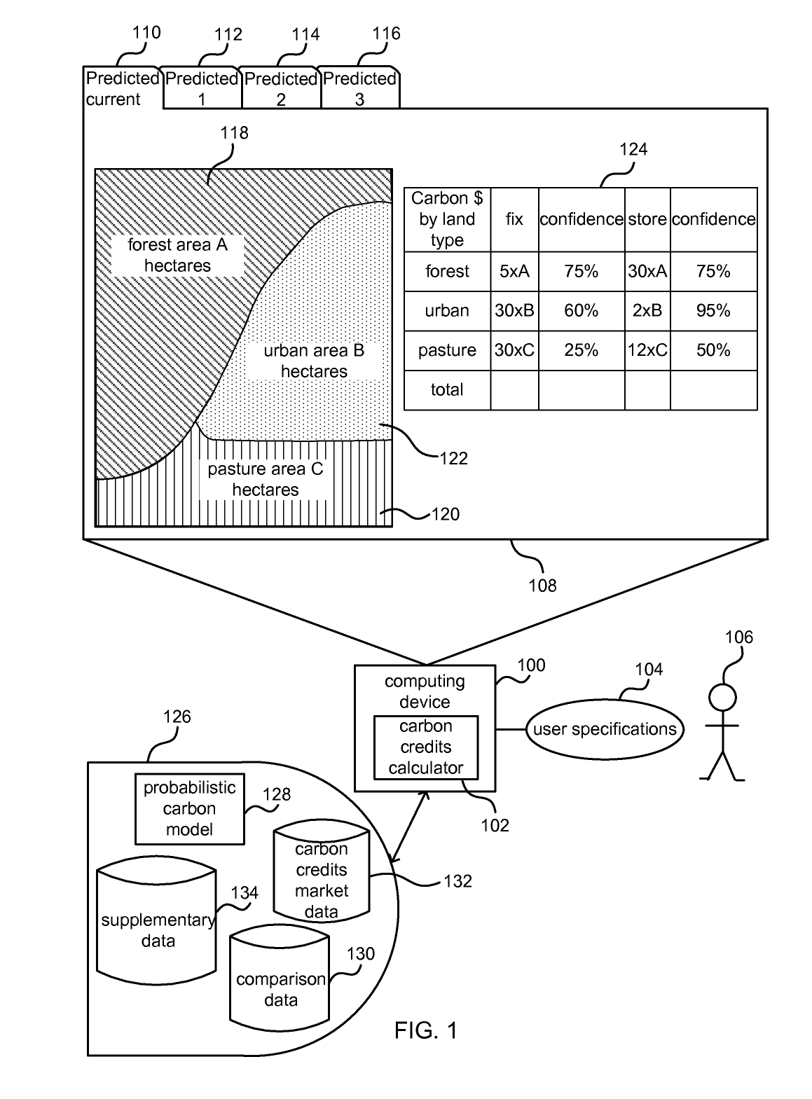

FIG. 1 is a schematic diagram of a carbon credits calculator 102 at a computing device 100 being used by a user 106 to display carbon credit monetary values for a geographical area. Suppose the user 106 is planning a land management project for a specified geographical area. A map of the specified geographical area may be displayed by the computing device 102 indicating current land use. In the example of FIG. 1 the specified geographical area is a relatively small piece of land. However, other geographical areas may be used such as whole countries or continents. The carbon credits calculator 102 is able to calculate and display a table 124 or other format of carbon credits monetary values and associated confidences to aid the user in planning the project. The carbon credits calculator 102 may make the calculations under different scenarios (land use scenarios, climate scenarios and other scenarios) and for different times or time periods historically, currently or into the future. The carbon credits calculator 102 is able to access a probabilistic carbon model 128 (or other model such as an earth system model, which incorporates a probabilistic carbon model), carbon credits market data 132, comparison data 130, maps of geographical areas (such as from a web-based map service), and supplementary data 134 such as other mapped data sources (e.g. crop yield data, ecosystem service value). For example, the comparison data may be satellite derived empirical estimates of land carbon (other examples of comparison data are described below). The carbon credits calculator 102 may obtain predictions from the probabilistic carbon model, for example, predicting a current potential amount of terrestrial carbon in a specified unit area of land and a certainty of that prediction. For example, a prediction may be a value that the carbon model computes with 95% confidence that it is correct. It is also possible to refer to an uncertainty of a prediction. For example, a prediction may be a value that the carbon model computes with 5% uncertainty. The predicted current potential amount of terrestrial carbon may be thought of as—how much carbon would be present, given knowledge of vegetation types, vegetation behavior, rainfall, temperature, and other environmental factors—but assuming no land use by humankind. The carbon credits calculator 102 may compare the prediction from the probabilistic carbon model with corresponding amounts from the satellite carbon data and find a difference indicating how much carbon fixation and/or carbon storage may be achieved through change in land use. Alternatively the carbon credits calculator may directly estimate the amount of carbon sequestered over a time window given comparison data comprising estimates of the carbon contents for the geographical area.

A probabilistic carbon model is a system for representing one or more processes of atmospheric carbon exchange with biological systems with estimates of certainty. A probabilistic carbon model represents each carbon exchange process using one or more parameterized mathematical expressions. The values of the parameters may be learnt from training data, may be obtained empirically, or may be set by an operator. In the case of a probabilistic carbon model belief about the value of some parameters and/or the initial system state is represented by a probability distribution. A mean (or other statistic) of that probability distribution is related to an estimate of the parameter value. A variance (or other statistic) of the probability distribution is related to an estimate of the uncertainty in the estimate of the parameter value. In the examples described herein any suitable probabilistic carbon model may be used, such as that described in Smith et al. “The climate dependence of the terrestrial carbon cycle; including parameter and structural uncertainties.” Biogeosciences Discussions, 9, 13439-13496, 2012. The Smith et al. model is also described below.

The predicted potential amount of carbon may be represented as a monetary value, or distribution or range of monetary values, in the display by enabling the carbon credits calculator to access the carbon credit market data 132. For example, the probabilistic carbon model may predict a current carbon amount for urban area A in FIG. 1. The difference between that predicted current amount and the corresponding satellite carbon data may indicate how much carbon could be fixed in that land by changing its use

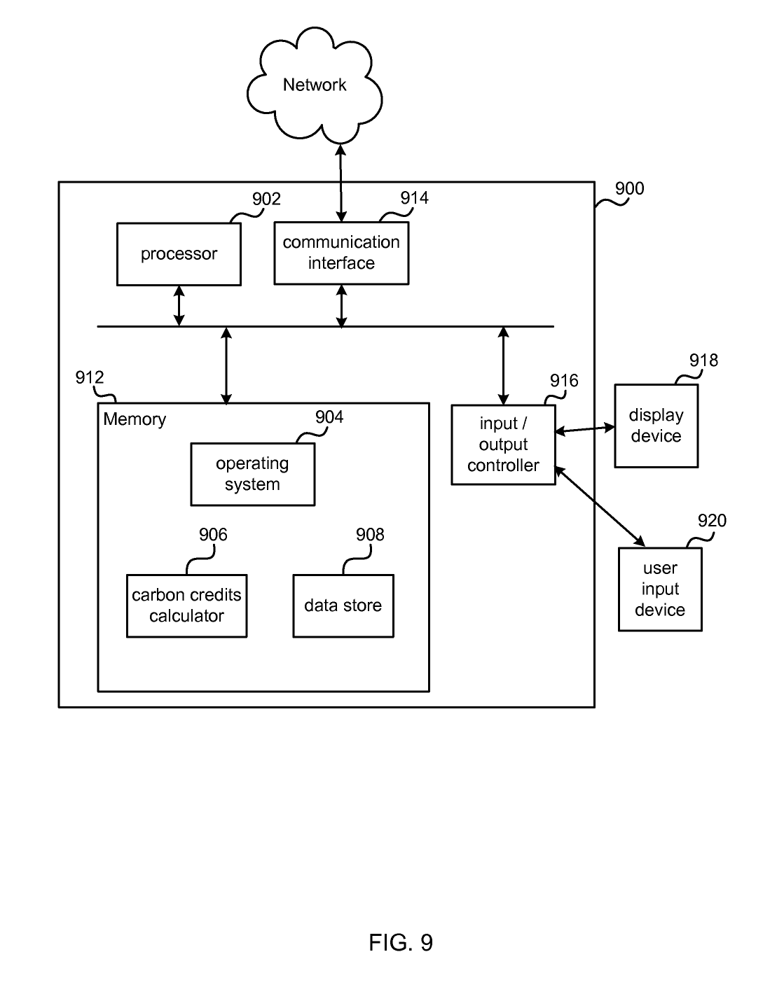

In the example of FIG. 1 the carbon credits calculator is shown at computing device 102 but this is not essential. All or part of the carbon credits calculator may be located at another computing entity which is in communication with the computing device 102. The computing device 102 may be any computing device such as that described later with reference to FIG. 9.

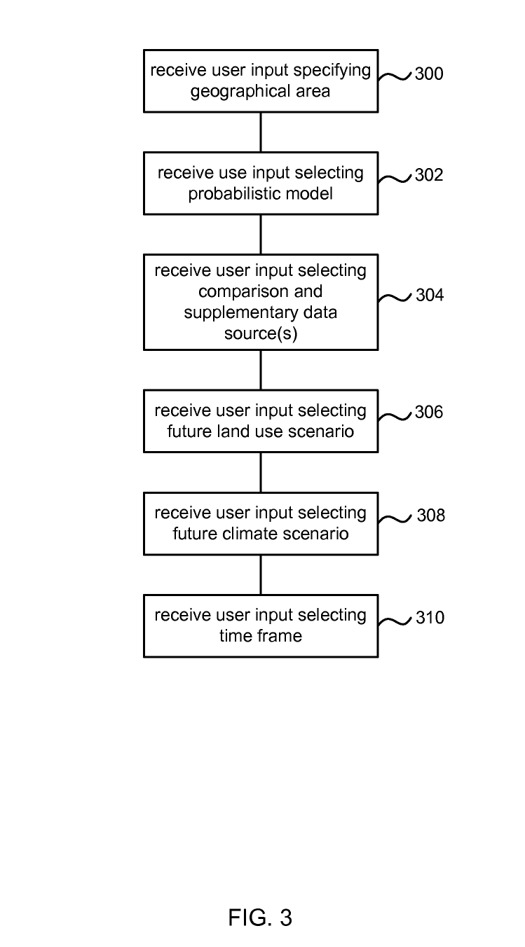

The carbon credits calculator 102 may be implemented using software or hardware. It is able to control a display of carbon credits monetary values under one or more land use or other scenarios. For example the display may be made at a display screen integral with the computing device itself or at another location. The carbon credits calculator 102 is able to receive user specifications 104. For example, the computing device 100 has one or more user input mechanisms whereby a user is able to enter the user specifications 104; the computing device may then send the user specifications to the carbon credits calculator 102. Examples of user specifications are given below with reference to FIG. 3 and may comprise details of geographical areas to be considered, sources of comparison data, choices of probabilistic carbon model, and other details.

As mentioned above the carbon credits calculator is able to access a probabilistic carbon model 128 (or other model such as an earth system model, which incorporates a probabilistic carbon model), carbon credits market data 132, comparison data 130, supplementary data 134 and maps of geographical areas.

In an example, the probabilistic carbon model is fully data-constrained in that, for each parameter, a probability distribution representing knowledge of the parameter's value is inferred from empirical data. This provides the benefit that an estimate of confidence in model predictions can be derived from estimates of confidence in how accurately the model represents the underlying processes. In various manifestations such actual or estimated improvements in confidence may be quantified in terms of carbon credits.

In FIG. 1 the probabilistic carbon model 128, comparison data 130, supplementary data 134, and carbon credits market data 132 are shown in a schematic communications network 126 and are accessible to the computing device 100 over a suitable communications interface of any type.

The carbon credits market data 132 comprises numerical price data reported from carbon credits trading venues such as stock exchanges. The carbon credits market data 132 may also comprise quote and trade related data associated with carbon credits such as one or more of: the bid price (also known as the sell price), the ask price (also known as the offer or buy price), the highest bid price and the lowest ask price per individual carbon credit market maker, the depth of orders, and other quote and trade related data. The carbon credits market data 132 may comprise historical carbon credits market data. It may also comprise live carbon credits market data. The live data may be provided as an input stream from a stock exchange or other carbon market. The carbon credits market data 132 may also comprise predicted or projected carbon credits market data obtained from economic models, models of carbon credit markets and other sources. The carbon credits market data 132 may be in the form of probability distributions or some other form of a range of values.

Although FIG. 1 shows a single database of carbon credits market data 132 it is possible for the carbon credits market data 132 to be accessed from a plurality of disparate sources. In some examples all or some of the carbon credits market data 132 is input as part of the user specifications 104.

The comparison data 130 comprises numerical values of amounts of carbon present terrestrially in specified geographical areas; or data from which those numerical values can be derived or estimated. The comparison data may be empirically derived through field studies, satellite observations and other measurements. The comparison data may be estimated from another carbon model, or models (which may or may not be probabilistic). It is also possible for the comparison data to be obtained by a combination of empirical measurement and estimation using a carbon model or other estimation method.

The supplementary data 134 comprises other third party datasets that might be informative to the user when considering the outputs of the carbon credits calculator but do not directly relate to carbon. The supplementary data may be empirically derived through field studies, satellite observations and other measurements. The supplementary data may be estimated from another models, or models (which may or may not be probabilistic). Although FIG. 1 shows a single source of comparison data 130 and a single source of supplementary data 134 for clarity; in practice, many different sources of comparison data and supplementary data may exist. A user 106 is able to specify which comparison data source(s) are to be used as part of the user specifications 104. The user may also specify parts of comparison data sources to be used and may specify how these are to be used to derive or estimate numerical values of carbon where that is carried out by the carbon credits calculator 102. The user is also able to specify supplementary data source(s).

Where the comparison data needs to be used to derive or estimate numerical values of carbon present terrestrially in specified geographical areas, the carbon credits calculator 102 may comprise functionality to carry out the derivation or estimation. The carbon credits calculator may use other sources of information to enable the derivation or estimation.

The carbon credits calculator may also comprise functionality to reformat and/or rescale the comparison data and the supplementary data such that it is suitable for direct comparison with output from the probabilistic carbon model 128. For example, the reformatting may comprise changing the units of measurement to make those compatible with output from the probabilistic carbon model 128, changing the type of the numerical values from floating point values to integers (or similar type change), rounding numerical values to a specified number of decimal places, removing outliers, removing noise or erroneous values, and other actions.

The carbon credits calculator 102 may comprise functionality for reading in and processing the comparison and supplementary data. For example, where the comparison data is available at a web service or database the carbon credits calculator may query the web service or database to obtain the comparison or supplementary data.

Alternatively, or in addition, the functionality described herein with respect to the carbon credits calculator can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), graphics processing units (GPUs).

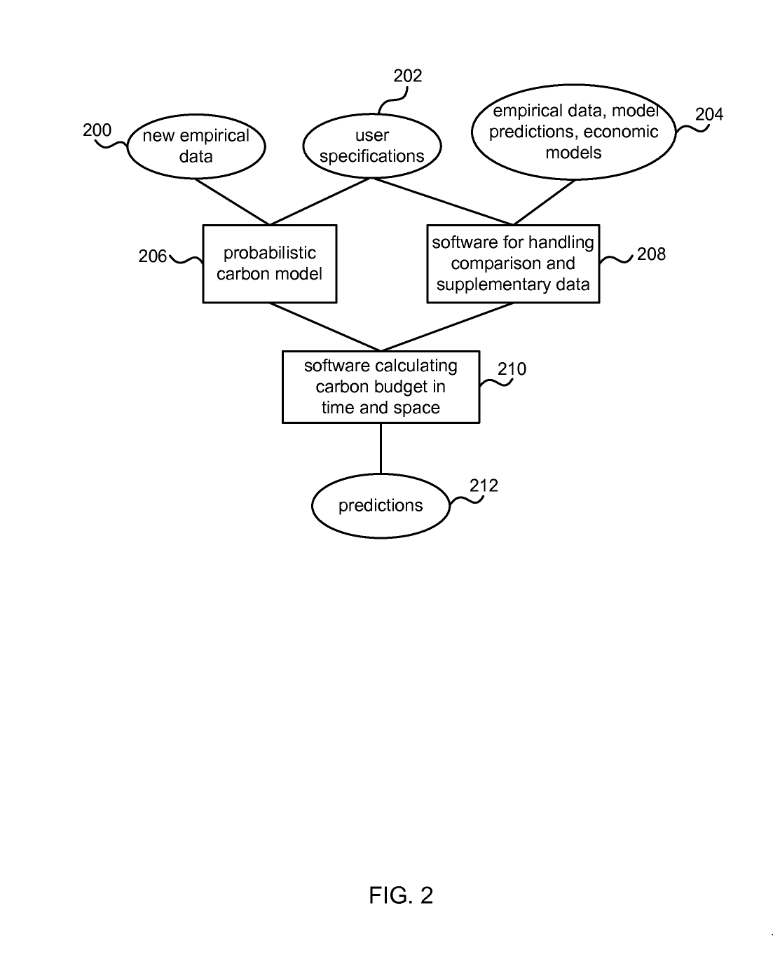

FIG. 2 shows a probabilistic carbon model 206, software 208 for handling comparison data and software 210 for calculating a carbon budget in time and/or space. The probabilistic carbon model may be the probabilistic carbon model of FIG. 1 as described above which predicts amounts of carbon stored terrestrially assuming vegetation is in, or returns to, its natural state (without intervention by human kind). The probabilistic carbon model may have been trained using empirical data such as new empirical data 200. More detail about how a probabilistic carbon model may be trained using empirical data is given later in this document. The probabilistic carbon model 206 may receive user specifications 202 which specify which of one or more model components are to be used where the probabilistic carbon model is a multi-component model. The user specifications 202 may also select which empirical data is to be used to train the model and/or which of a plurality of training methods are to be used.

The software 208 for handling comparison and supplementary data may receive user specifications 202 selecting which one or more sources of data to use. The user specifications may also select which of one or more options to use to process the comparison and supplementary data. The software 208 for handing comparison and supplementary data is arranged to read in and process data such as empirical data 204, carbon model predictions (from a second carbon model) and/or predictions from economic models.

The software 208 for handling comparison and supplementary data and the software 210 for calculating a carbon budget may be integral with the carbon credits calculator 102 of FIG. 1. The output of the software 210 for calculating carbon budget in time and/or space comprises predictions 212 of current, past or future carbon credit values of specified geographical areas under specified land use, climate or other scenarios.

FIG. 3 is a flow diagram of a method at the carbon credits calculator 102 of FIG. 1 for receiving the user specifications. Each of the steps in the flow diagram is optional because the user specifications are not essential. The selections made by the user may alternatively be made by the carbon credits calculator automatically or may be pre-configured.

The carbon credits calculator 102 receives user input specifying a geographical area 300. For example, the user may input latitude and longitude ranges to specify a geographical area. This may be achieved in any suitable way such as by presenting a graphical display of a map to the user which may be zoomed in or out and used to select a geographical area for analysis by the carbon credits calculator 102.

The carbon credits calculator may receive user input specifying which of a plurality of probabilistic carbon models to be used 302, or which one or more components of a multi-component probabilistic carbon model to use.

The carbon credits calculator may receive user input specifying one or more comparison and supplementary data sources to be used 304.

The carbon credits calculator may receive user input specifying a future land use scenario 306. For example, return to natural vegetation, urban, pasture, deforestation, or others.

The carbon credits calculator may receive user input specifying a future (or current) climate scenario 308. For example, a plurality of climate scenarios may be available where the probabilistic carbon model is part of an earth system model.

The carbon credits calculator may receive user input specifying a time frame 310 over which the carbon credit values are to be calculated. For example, where a land use change involves re-forestation this may comprise a carbon credit value per year over a plurality of years of the time frame.

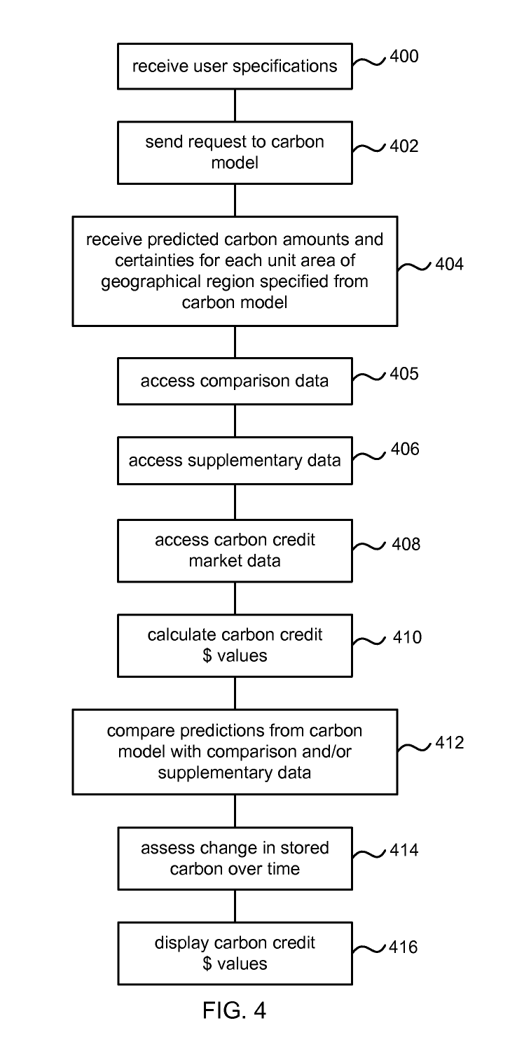

FIG. 4 is a flow diagram of a method at a carbon credits calculator such as that of FIG. 1. User specifications are received 400 as described above with reference to FIG. 3. The carbon credits calculator sends 402 a request to the probabilistic carbon model. For example, the request has a plurality of arguments which comprise selections such as from the user specifications or which are preconfigured or selected by the carbon credits calculator automatically. The carbon credits calculator receives 404, from the probabilistic carbon model, predicted carbon amounts and certainties for each unit area of a specified geographical region. The predicted carbon amounts are for the situation where vegetation returns to its natural state (without intervention by humankind).

The carbon credits calculator accesses 405 supplementary data. For example the user specifications may indicate supplementary data comprising maps of crop yields or ecosystem service values to be considered. In light of this information the user may adjust the specifications of the geographical regions for which they wish to calculate carbon credits values.

The carbon credits calculator accesses 406 comparison data. For example, the user specifications may indicate a data source to be used. The carbon credits calculator reads in and processes the comparison data so that it is in a form suitable for comparison with the predictions from the probabilistic carbon model.

The carbon credits calculator accesses 408 carbon credit market data. For example, the carbon credits calculator may select carbon credit market data for particular time frames, or markets according to user specifications, according to its knowledge of the geographical area being assessed or according to other factors.

The carbon credits calculator optionally calculates carbon credit monetary values 410 from the predicted carbon amounts obtained at step 404 and from the market data obtained at step 408. The carbon credit monetary values 410 may be displayed to the user in order to show the monetary values available if land in the geographical region being considered were to be allowed to return to its natural vegetation state, or the monetary values available if land were to be prevented from being converted from its natural vegetation state. These are examples only, other carbon credit monetary values may be calculated and displayed.

The carbon credits calculator compares the predictions and the associated certainties from the probabilistic carbon model obtained at step 404 with the comparison data. In the case where the comparison data comprises carbon amounts for a land use scenario that is different from a natural vegetation state, the difference between the model predictions and the comparison data gives an indication of the potential carbon that may be gained (or lost) through altered land use (such as by returning urban land, or pasture land to natural vegetation). More than one set of comparison data may be used in order to obtain potential carbon values for different scenarios. For example, where urban land is converted back to natural vegetation the potential carbon value may represent the amount of carbon which can be removed from the atmosphere through carbon fixation as the vegetation returns. Carbon credit values associated with the potential carbon fixation may be displayed 416 to a user together with certainties associated with those values. Because the probabilistic carbon model gives as output predictions in the form of probability distributions, the carbon credits calculator is able to calculate both carbon credit monetary values and certainties associated with those values. The certainty information may be presented to the user in a variety of ways. For example, graphically as error bars, color shading on a map of a geographical region, by omitting to display data that is below a threshold certainty, by graphical display of the probability distributions themselves, or in other ways.

The carbon credits calculator is also able to estimate 414 a change in stored carbon over time. For example, in regions where land is currently heavily disturbed by grazing, the amount of carbon that will be stored through time if the land is instead allowed to return to natural vegetation may be calculated in terms of monetary value and displayed 416 to a user together with a percentage value, error bar or other indicator of how certain the estimate is.

The carbon credits calculator may also assess a change in stored carbon over time, for example, where climate change occurs. For example, the predictions from the probabilistic carbon model may be for a specified climate (such as the current climate) and relate to amounts of carbon assuming natural vegetation states (without intervention by humankind). The comparison data may be predictions from a second probabilistic carbon model which is the same as the first probabilistic carbon model except that it operates under the assumption of a second specified climate (such as a predicted climate under global warming of a specified amount). The carbon credits calculator is then able to compare the predictions of the two models and obtain an estimate of the amount of change in stored carbon in pristine vegetation areas should the climate change under global warming by the specified amount. Certainties associated with the estimates are also calculated by the carbon credits calculator using the probability distributions from the first and second probabilistic model outputs.

In the example described above the first and second probabilistic carbon models may be the same probabilistic carbon model run under different climate settings. For example, where the probabilistic carbon model is part of an earth system model which takes into account one or more climate change scenarios.

In an example, a country may decide to assess the change in the carbon value of its land over the coming two decades under different land use change scenarios. A government department or other body is able to use the carbon credits calculator to obtain from the probabilistic carbon model, estimates of the potential storage of carbon across the country. The government department may provide or specify the comparison data to be used. For example, current empirical estimates of stored carbon across the country. The government department may investigate the monetary value of the conservation of several large areas of pristine forest for carbon storage purposes, and the carbon sequestration potential of allowing certain areas of unproductive farmland to recover to natural vegetation. Suppose that a monetary value of carbon is $30 per metric tonne. The carbon credits calculator calculates the change in the carbon stored in the pristine vegetation over the time period. The carbon credits calculator also calculates the amount of carbon fixed by the ex-agricultural land. The predictions of carbon fixed (such as 200 tonnes a hectare, $300 a year over 20 years) may be expressed as probability distributions enabling the users to assess the level of uncertainty in the values and the level of financial risk taken in committing to the predictions of the carbon credits calculator.

In an example, user specifications are received selecting a time period for assessing carbon credit monetary value of the geographical area. The carbon credits calculator may obtain a plurality of predictions from the carbon model over the time period; and calculate carbon credit monetary values for the geographical area over the time period using the plurality of predictions.

In an example, user specifications are received selecting at least one land use scenario for the geographical area. The carbon credits calculator accesses comparison data appropriate for the land use scenario and calculates the carbon credit monetary values for the geographical area and the land use scenario using the prediction.

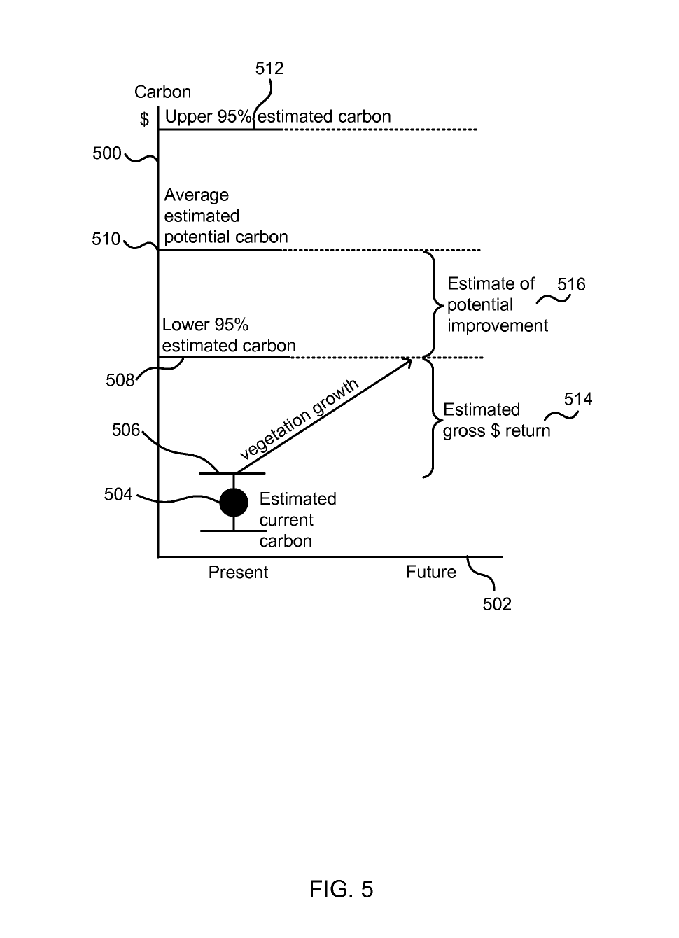

FIG. 5 is a graph of carbon stored in a specified area of land over time. This graph is now used to discuss how the carbon credits calculator may be used to calculate monetary value achieved through carbon fixation at the site. The y axis 500 represents carbon amounts as monetary value. The x axis 502 represents time. An estimate of the current amount of carbon stored at the specified area is shown as point 504 on the graph and error bars are shown associated with that estimate. The higher error bar estimate 506 is shown. If vegetation at the specified area is returned to its natural state an average estimated potential carbon amount 510 for the area of land may be found from the probabilistic carbon model. Associated with the average estimated potential carbon amount is certainty information. The certainty information is shown on the graph as a lower 95% estimated carbon value 508 and an upper 95% estimated carbon level 512. These 95% values may be the 5^{th} and 95^{th} centiles of a probability distribution representing belief about the amount of carbon present. Typically, carbon credit schemes use the lower 95% estimate when assigning carbon credits. Therefore the estimated gross monetary 514 return is represented by the amount indicated on the graph of FIG. 5. This is the monetary return which may be expected from changing the use of the land from its current use to natural vegetation over the time period shown in the graph. The carbon credits calculator described above is able to calculate the estimated gross monetary return 514 as described above. However, the carbon credits calculator is also able to calculate an estimate of potential improvement 516. This is the difference between the lower 95% estimate carbon level and the average estimated potential carbon amount 510. This monetary value may be calculated and displayed to a user. It provides an indication of additional monetary value that may become available through carbon credits associated with the land, should more accurate estimates of the average estimated potential carbon become available in future.

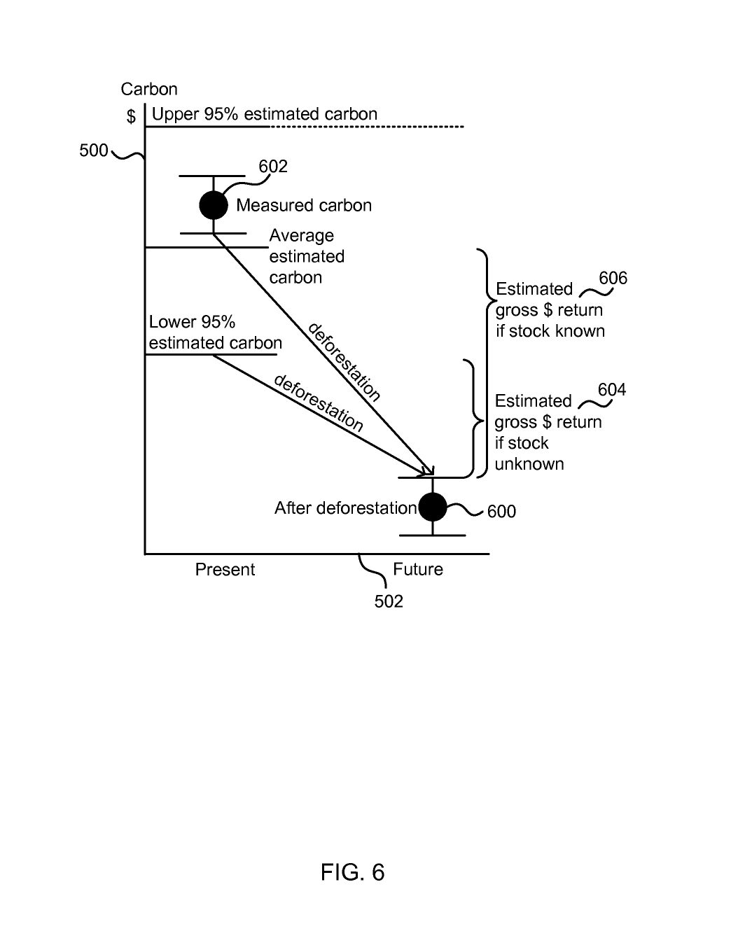

FIG. 6 is a graph of carbon stored in a specified area of land over time. This graph is now used to discuss how the carbon credits calculator may be used to calculate monetary value achieved through carbon storage at the site (in this case, value through not removing vegetation from the site). The y axis 500 represents carbon amounts as monetary value. The x axis 502 represents time. A measurement of the current amount of carbon stored at the specified area is shown as point 602 on the graph and error bars are shown associated with that measurement. If vegetation removal at the specified area occurs the estimated amount of carbon drops to point 600 on the graph.

An average estimated carbon amount for the site before deforestation is available from the probabilistic carbon model and is shown on the graph. Associated with the average estimated carbon amount is certainty information from the model. The certainty information is shown on the graph as a lower 95% estimated carbon value and an upper 95% estimated carbon level. These 95% values may be the 5^{th} and 95^{th} centiles of a probability distribution representing belief about the amount of carbon present. Typically, carbon credit schemes use the lower 95% estimate when assigning carbon credits. Therefore the estimated gross monetary return 604 (of not deforesting the site) is represented by the amount indicated on the graph of FIG. 5. This is the monetary return which may be expected from keeping the forest pristine and not deforesting the site. The carbon credits calculator described above is able to calculate the estimated gross monetary return 604 as described above. However, the carbon credits calculator is also able to calculate an estimated gross return 606 by using the average estimated carbon value from the probabilistic model. This estimated gross monetary return if the carbon amount is known more accurately may be calculated and displayed to a user. It provides an indication of additional monetary value that may become available through carbon credits associated with the land, should more accurate estimates of the amounts of carbon at the site become available. This enables a cost benefit analysis to be carried out to decide whether to carry out field studies or other empirical studies of the amount of carbon at the site.

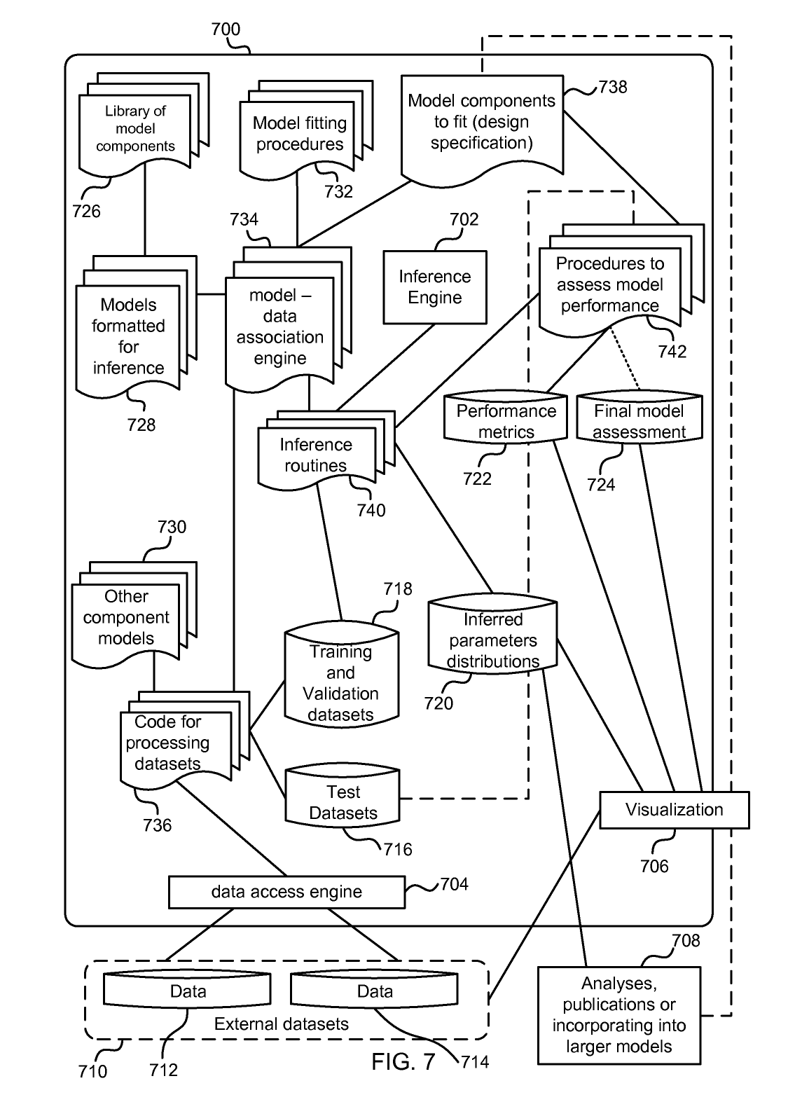

FIG. 7 is a schematic diagram of an engineering system for multi-component models for use in the situation where the probabilistic carbon model is a multi-component model or itself is part of an earth system model or other multi-component model.

The engineering system 700 may be used to establish which model components are to be used, how these are interconnected, and which data sets are to be used to train, validate and test the model and/or model components. The engineering system 700 may also be used to establish how performance of the resulting model is to be assessed, for example, by formally comparing model predictions with data in specific ways. The engineering system optionally includes a facility to visualize model performance assessment results, predictions and/or simulations generated by the model and uncertainty of parameters of the various component models. The engineering system 700 provides a framework to enable scientists to develop and refine models of complex dynamical systems in an efficient, repeatable and consistent manner. Using the system scientists are able to define multi-component models, to couple the component models with datasets, to assess the component models and the whole multi-component model and to assess where most of the uncertainty or inconsistency lies within the multi-component model.

In the example of FIG. 7 a plurality of libraries of model components 726, 730 are shown. These may be in the form of source code, software binaries or other software specifying functions representing biological, physical or other dynamical processes. Different versions of the model components may be selected by an operator to form a multi-component predictive model. In this way the engineering system enables scientists to define multi-component models in a simple, repeatable and rigorous manner. In the case that the engineering system is used to form a dynamic global vegetation model (DGVM) the libraries of model components 726, 730 may comprise a library of vegetation component models and a library of other component models such as soil hydrology models.

One or more software binaries 728, source code or other forms of software is provided for formatting the model components for inference. For example, this comprises selecting which parameters are to be inferred and initializing those parameters by establishing a data structure in memory to hold information about probability distributions associated with the parameters and setting those to default initial values such as zero or 1. In an example the software for formatting the model components for inference comprises inference engine elements comprising software provided in a file or other structure, as a class of an object oriented programming language, or other formats.

Data to be used to train the model components and to assess the trained model is obtained from data sets 710 accessible to the model engineering and refinement system. In the example shown in FIG. 7 two external data sets 712, 714 are shown. One or more data sets may be used and these may be internal or external to the system. In some cases one or more of the data sets are available via remote web services. The data may be in different formats and comprise values of different types according to the particular research domain.

A data access engine 704 may comprise a plurality of object-oriented software classes which may be used to enable data to be passed from the data sets 712, 714 (which are in various formats) into other software in the engineering system in a manner independent of the original format of the data in the datasets. An example of software for use in the data access engine 704 is given in U.S. patent application Ser. No. 12/698,654 “Data array manipulation” filed on 2 Feb. 2010 and published as US20110191549. The data access engine 704 may also comprise one or more libraries of software which provide an application programming interface to a remote web service which provides data.

Software code 736 for processing the datasets may be included in the model engineering system, for example, to partition the data into one or more test portions and one or more training and validation portions. A plurality of training and validation portions (sometimes referred to as folds of data) may be formed from the datasets in the case that cross-validation is to be used during a model assessment process. Cross-validation may involve training a model using 9/10ths of a portion of data and then validating the trained model using the remaining 1/10^{th} of the portion of data (other fractions of the data may be used, 9/10 and 1/10 is only one example). This process may then be repeated for different folds of the data; that is training the model using a different 9/10ths of the data and so on. The software code 736 for processing the datasets outputs data (or addresses of locations of the data) into a training and validation dataset store 718 and also to a test dataset 716.

The software code 736 for processing the datasets may also be arranged to divide the data into portions in the case that a plurality of computers is used to carry out the parameter inference process. Different portions of data may be processed at different computers in order to enable large amounts of data to be processed in practical time scales.

The software code 736 for processing the datasets may have access to one or more data terms and conditions files for each dataset. These files are stored at a memory accessible to the model engineering system and enable a user to check that any terms and conditions for use of a particular dataset are complied with.

A model-data association engine 734 comprises software which associates or combines specified model components (which are in a format for use by an inference engine) with specified datasets. The result is passed to inference routines 740 which utilize an inference engine 702 to obtain estimates of the parameter probability distributions.

The inference engine 702 is arranged to perform parameter estimation (for example Bayesian parameter inference, or Maximum Likelihood parameter estimation when prior probability distributions are not specified). For example, the inference engine may use a Markov Chain Monte-Carlo method which estimates model parameters given data, a specified model, and prior parameter distributions. In other examples the inference engine may use Bayesian inference with graphical models although this is more suitable where the component models do not have arbitrary complexity. An example of an inference engine using a Markov Chain Monte-Carlo method which may be used is now described in more detail.

In this example the inference engine uses a form of the Metropolis-Hastings MCMC algorithm to sample from the joint posterior distribution of the parameters of a given model component. The Metropolis-Hastings MCMC algorithm is described in detail in “Chib S, Greenberg E (1995) Understanding the Metropolis-Hastings algorithm.” Am Stat 49:327-335. The algorithm enables the joint posterior distribution of the parameters to be estimated. The inference engine in this example calculates the probability of the empirical data given prior parameter distributions and the predictions of the parameterized model. This process repeats for each set of training data. It then uses update rules based on Baye's law to update prior distributions of the parameters and to obtain a joint posterior distribution. That joint posterior distribution is sampled using the MCMC algorithm and used as an updated prior distribution for the parameters.

In an example, a form of the Metropolis-Hastings MCMC algorithm is used, which conforms to the requirements for the Metropolis-Hastings MCMC algorithm to converge to the correct posterior distribution, is robust to the problem of local (non-global) maxima and converges quickly. In this algorithm, at each MCMC step, random changes are proposed to randomly selected parameters, where the number of parameters to be changed varies from one to the total number of parameters. Proposal distributions for each parameter are tuned during an initial ‘burn-in’ period (for example, 10,000 MCMC steps) to achieve an approximate Metropolis-Hastings acceptance rate of 0.25. This tuning is accomplished by iteratively adjusting the standard deviations of the normal random variables that define the proposal distributions. The standard deviations are fixed at the end of the burn-in period. Different proposal distributions may be used for parameters bounded between 0 and infinity, and parameters bounded between minus infinity and infinity, and the inference engine may omit explicitly including any prior information in the metropolis criterion. In this way non-informative priors may be used with different forms for the proposal distributions on each parameter (uniform over logarithm of values, uniform over untransformed values, respectively). Following the burn-in period, the Metropolis-Hastings MCMC algorithm is continued for a specified number of steps (e.g. 100,000 further steps) and a posterior sample is recorded at regular intervals (e.g. every 100^{th} MCMC step). These samples may be saved for error propagation in the calculation of analytical metrics, and in model simulations.

The inference routines 740 comprise for example routines for implementing the inference engine using different subsets of the collection of training data or subsets of model components; and in summarizing the outputs from the inference engine for subsequent processing.

A library of model fitting procedures 732 comprises a plurality of pre-inference processes, model fitting procedures and simulation procedures (where the fitted model is used to make predictions). A user is able to configure factors about the datasets and/or about the model components. A user is able to specify, for each model component, which formats of data are required. Also, a user may select, for a specified model component, which model parameters are to be inferred. Assigning a fixed value to a model parameter, rather than inferring the parameter's value from data, can help a user to alleviate or mitigate overfitting. Overfitting occurs when the number of inferred model parameters is sufficiently high that during training the model is formed to so closely match the training data that it is unable to generalize and make good predictions when data is input to the model that has not previously been seen by that trained model. A user is also able to configure parameters which specify how the data is to be divided into training, validation and test portions and, if a cluster of computers is to be used for inference, how to allocate data between members of the cluster. In addition, a user is able to specify the model fitting procedures to be used. For example, the full multi-component model may be fitted or run to generate simulations, individual specified model components may be fitted or run to generate simulations, one or more model components may be replaced by an alternative model component or a constant, or specified datasets may be sequentially omitted. Any combination of model fitting procedures may be specified.

A specification of model components to fit (design specification) 738 provides input to the model-data association engine and to procedures for assessing model performance 742. The specification 738 provides a list of names identifying the precise model components from the models formatted for inference for use in the model-data association engine, and for post-inference model assessment 742.

The procedures for assessing model performance 742 comprises a software library of routines which provide functionality such as a range of model performance assessment metrics or other assessment processes whereby a trained model component is assessed using training validation or test data, comparison processes whereby performance of a trained model component is compared with performance of an alternative formulation for that component, or compared using other standards. The output of the procedures for assessing model performance 742 may comprise performance metrics which are stored at a data store 722 at any suitable location. In some examples the performance metrics are obtained during a cross-validation process using training and validation datasets 718. A final model assessment 724 may then be made using a test dataset 716 and the results stored at final model assessment store 724.

A visualization engine 706 may be used to display the performance metrics 722, final model assessment 724 and inferred parameter probability distributions 720. The visualization engine also enables users to inspect and visualize graphically the data from the datasets which may be diverse.

The inferred parameter distributions 720 are optionally used for analysis, publications or incorporating into larger models 708.

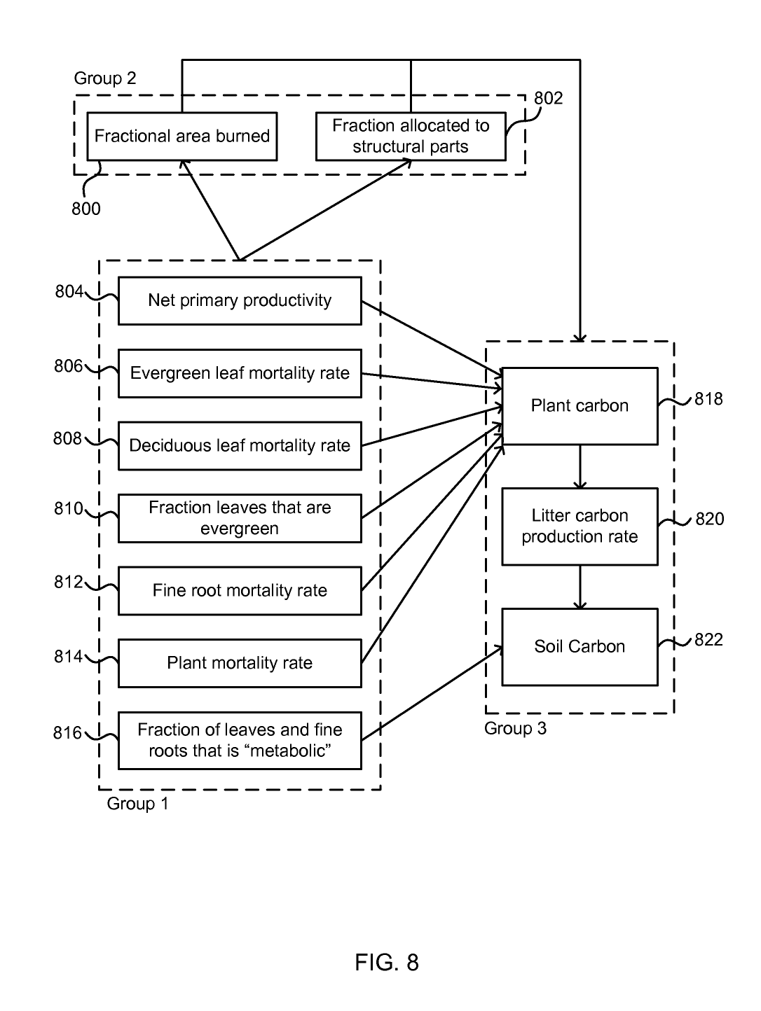

As mentioned above an example of a probabilistic carbon model which may be used is described in Smith et al. “The climate dependence of the terrestrial carbon cycle; including parameter and structural uncertainties” referenced above. A summary of that model (which is an equilibrium terrestrial carbon cycle model) is now given to aid understanding of operation of the carbon credits calculator described herein. The model is formulated as differential equations describing carbon fluxes through plant and soil pools. Assuming the carbon pools are in states of dynamic equilibrium (input rates equal output rates) the differential equations may be used to form a plurality of functional relationships. The probabilistic carbon model comprises a plurality of components as illustrated in FIG. 8 where boxes represent model components with accompanying data. Each model component comprises one or more functions representing a carbon process. Each function has one or more parameters and has arbitrary complexity. As mentioned above, probability distributions are assigned to the parameters of the model components representing the degree of certainty or uncertainty in the knowledge of that parameter's value. These probability distributions are initially set to default values, often incorporating prior knowledge about the parameters most likely values, and an inference engine repeatedly updates the probability distributions by comparing the predictions of a parameterized model with training data. For example, the mean of a probability distribution may represent the most probable value for a parameter and may be updated as more is learnt from training data about the value of the particular parameter. For example, the variance of a probability distribution may represent the degree of uncertainty about a parameter value. For example, the variance may be reduced representing increased certainty in the knowledge of the parameter value as more is learnt from the training data.

In FIG. 8, arrows connect a model component that acts as a sub-component (tail of arrow) to another model component (head of arrow). Model components 804, 806, 808, 810, 812, 814, 816 within group 1 do not require predictions from other model components to predict their accompanying data sets. Group 2 model components 800, 802 take in predictions from the net primary productivity model component 804. Group 3 model components 818, 820, 822 take input from a plurality of model components as indicated.

As mentioned above, model components 804, 806, 808, 810, 812, 814, 816 within group 1 do not require predictions from other model components to predict their accompanying data sets. The net primary productivity model component 804 models net carbon fixation by vegetation (photosynthesis minus respiration). The evergreen leaf mortality rate component models how fast evergreen leaves die in the absence of fire. The deciduous leaf mortality rate component 808 models how fast deciduous leaves die in the absence of fire. The fraction of leaves that are evergreen component 810 models the proportion of leaves in an area of land which are evergreen. The fine root mortality rate component 812 models how fast fine roots of plants die in the absence of fire. The plant mortality rate component 814 models not fast plants die in the absence of fire. The fraction of leaves and fine roots that is metabolic component 816 models the proportion of leaves and fine roots that become soil.

The components in group 2 comprise a model 800 of the fractional area burned and a model component 802 of the fraction of vegetation allocated to structural parts. This enables mortality due to fire to cause fine root carbon to be added to the soil but releases all leaf and structural carbon as carbon dioxide.

The component in group 3 comprise a plant carbon model component 818, a litter carbon production rate model component 802 which models leaf litter and woody debris laying above the soil, and a soil carbon mode component 822 which models organic carbon held within the soil. Outputs from the model components in group 3 provide predictions of amounts of carbon and associated certainties for use by the carbon credits calculator.

Although the probabilistic carbon model described immediately above is a model of the equilibrium terrestrial carbon cycle it is also possible to use a probabilistic carbon model which takes into account disequilibrium states.

FIG. 9 illustrates various components of an exemplary computing-based device 900 which may be implemented as any form of a computing and/or electronic device, and in which embodiments of a carbon credits calculator may be implemented.

Computing-based device 900 comprises one or more processors 902 which may be microprocessors, controllers or any other suitable type of processors for processing computer executable instructions to control the operation of the device in order to access a probabilistic carbon model, calculate carbon credits and cause display of the calculated carbon credits. In some examples, for example where a system on a chip architecture is used, the processors 902 may include one or more fixed function blocks (also referred to as accelerators) which implement a part of the method of FIG. 4 in hardware (rather than software or firmware). Platform software comprising an operating system 904 or any other suitable platform software may be provided at the computing-based device to enable application software to be executed on the device. A carbon credits calculator 906 is provided which is able to access one or more probabilistic carbon models and to calculate carbon credits. A data store 908 is able to store maps, user specifications, outputs from probabilistic carbon models, comparison data, carbon credit market data, and other information.

The computer executable instructions may be provided using any computer-readable media that is accessible by computing based device 900. Computer-readable media may include, for example, computer storage media such as memory 912 and communications media. Computer storage media, such as memory 912, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 912) is shown within the computing-based device 900 it will be appreciated that the storage may be distributed or located remotely and accessed via a network or other communication link (e.g. using communication interface 914).

The computing-based device 900 also comprises an input/output controller 916 arranged to output display information to a display device 918 which may be separate from or integral to the computing-based device 900. The display information may provide a graphical user interface. The input/output controller 916 is also arranged to receive and process input from one or more devices, such as a user input device 920 (e.g. a mouse, keyboard, camera, microphone or other sensor). In some examples the user input device 920 may detect voice input, user gestures or other user actions and may provide a natural user interface (NUI). This user input may be used to provide user specifications as described above with reference to FIG. 3. In an embodiment the display device 918 may also act as the user input device 920 if it is a touch sensitive display device. The input/output controller 916 may also output data to devices other than the display device, e.g. a locally connected printing device.

The input/output controller 916, display device 918 and optionally the user input device 920 may comprise NUI technology which enables a user to interact with the computing-based device in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, rgb camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A computer-implemented method comprising:
receiving user specifications indicating a geographical area to be assessed for carbon credit monetary value;
obtaining at least one prediction from a carbon model predicting amounts of terrestrial carbon at the geographical area, the prediction being associated with a probability distribution;
accessing carbon credit market data;
at a processor, calculating at least one carbon credit monetary value associated with the geographical area using the prediction and the carbon credit market data;
causing display of the carbon credit monetary value.

2. A method as claimed in claim 1 comprising, at the processor, calculating a certainty of the at least one carbon credit monetary value using information about the probability distribution associated with the prediction; and causing display of the certainty.

3. A method as claimed in claim 1 comprising accessing comparison data for the geographical area, the comparison data comprising an amount of terrestrial carbon at the geographical area or data from which that amount is estimated.

4. A method as claimed in claim 3 comprising processing the comparison data in order that it is in the same units of measurements and scale as the at least one prediction.

5. A method as claimed in claim 1 the at least one prediction being of terrestrial carbon assuming no intervention by humankind at the geographical area.

6. A method as claimed in claim 1 comprising, at the processor, comparing the at least one prediction with the comparison data to obtain a difference, calculating a carbon credit monetary value of the difference and causing display of the calculated carbon credit monetary value.

7. A method as claimed in claim 3 wherein the comparison data is from a second probabilistic carbon model.

8. A method as claimed in claim 1 comprising accessing supplementary data about the geographical area and causing display of the supplementary data.

9. A method as claimed in claim 1 comprising receiving user specifications selecting a time period for assessing carbon credit monetary value of the geographical area; obtaining a plurality of predictions from the carbon model over the time period; and calculating carbon credit monetary values for the geographical area over the time period using the plurality of predictions.

10. A method as claimed in claim 1 comprising calculating a centile of the probability distribution and using the calculated centile together with the carbon credits market data to calculate a first estimated monetary return of carbon fixation or carbon storage at the geographical area; and using a statistic of the probability distribution to calculate a potential improvement with respect to the first estimated monetary return to be gained through accurate measurement of terrestrial carbon at the site.

11. A method as claimed in claim 1 comprising receiving user specifications selecting at least one climate scenario; obtaining the at least one prediction from the carbon model for the climate scenario; and calculating the carbon credit monetary values for the geographical area and the climate scenario using the prediction.

12. A method as claimed in claim 1 comprising receiving user specifications selecting at least one land use scenario for the geographical area; accessing comparison data appropriate for the land use scenario; and calculating the carbon credit monetary values for the geographical area and the land use scenario using the prediction.

13. A method as claimed in claim 1 at least partially carried out using hardware logic selected from any one or more of: a field-programmable gate array, a program-specific integrated circuit, a program-specific standard product, a system-on-a-chip, a complex programmable logic device.

14. A computer-implemented method comprising:
receiving user specifications indicating a geographical area to be assessed for carbon credit monetary value;
obtaining at least one prediction from a carbon model predicting amounts of terrestrial carbon at the geographical area, the prediction being associated with a probability distribution;
accessing carbon credit market data;
accessing comparison data comprising information about terrestrial carbon amounts at the geographical area;
at a processor, calculating at least one carbon credit monetary value associated with the geographical area by comparing the prediction and the comparison data, and by using the carbon credit market data;
causing display of the carbon credit monetary value.

15. A method as claimed in claim 14 where the at least one prediction from the carbon model is of terrestrial carbon at the geographical area assuming a first land use at the geographical area and the comparison data comprises terrestrial carbon at the geographical area assuming a second land use at the geographical area, different from the first land use.

16. An apparatus comprising:
an input controller arranged to receive user specifications indicating a geographical area to be assessed for carbon credit monetary value;
a communications interface arranged to obtain at least one prediction from a carbon model predicting amounts of terrestrial carbon at the geographical area, the prediction being associated with a probability distribution;
the communications interface being arranged to access carbon credit market data;
a carbon credits calculator arranged to calculate at least one carbon credit monetary value associated with the geographical area using the prediction and the carbon credit market data; the carbon credits calculator also arranged to cause display of the carbon credit monetary value.

17. An apparatus as claimed in claim 16 the carbon credits calculator being arranged to calculate a certainty of the at least one carbon credit monetary value using information about the probability distribution associated with the prediction; and to cause display of the certainty.

18. An apparatus as claimed in claim 16 the communications interface being arranged to access comparison data for the geographical area, the comparison data comprising an amount of terrestrial carbon at the geographical area or data from which that amount is estimated.

19. An apparatus as claimed in claim 18 the carbon credits calculator being arranged to compare the at least one prediction with the comparison data to obtain a difference, calculate a carbon credit monetary value of the difference and cause display of the calculated carbon credit monetary value.

20. An apparatus as claimed in claim 16 the carbon credits calculator being at least partially implemented using hardware logic selected from any one or more of: a field-programmable gate array, a program-specific integrated circuit, a program-specific standard product, a system-on-a-chip, a complex programmable logic device.
